(19) United States
(12) Patent Application Publication
(10) Pub. No.: US 2003/0056331 A1
(43) Pub. Date: Mar. 27, 2003

(54) Method and apparatus for providing a door hinge with integral doorstop

(76) Inventor: Wiley E. Garner, Temple, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/929,835

(22) Filed: Aug. 14, 2001

(51) Int. Cl. E05D 11/06

(52) U.S. Cl. 16/374

(57) ABSTRACT

There is disclosed a hinge apparatus for providing an integral doorstop. The hinge comprises two plates that pivot about a common pivot point. An elongate stop member is attached at one end to one of the plates and extends through and is movable in an opening defined by the other plate. A collar is selectively longitudinally movable on the stop member such that the plates can pivot between a first and second position but cannot pivot beyond a desired position. A method of providing a hinge with an integral doorstop is also disclosed.

### FIELD OF INVENTION

The present invention relates generally to hinges for doors, and, more specifically, to a door hinge that includes an integral doorstop.

### BACKGROUND OF THE INVENTION

In order for doors to open and close, they are usually attached to the door casement or doorjamb with one or more door hinges. Door hinges typically include a plate for attachment to the door, another plate for attachment to the doorjamb and a pivot pin interconnecting the two plates so that the plate attached to the door can pivot about the pivot pin. When pivoted on the pivot pin, the door usually has a range of motion from a fully closed position to a position between 90° and 180° from the closed position.

Frequently, it is desired to prevent a door from opening all the way to its fully open position. The reasons for this include the placement of furniture behind a door that would be damaged by the door contacting the furniture if opened beyond a particular position, damage to a wall or wood work located behind the door, and the like. Therefore, it is known in the art to provide a device to restrict the degree to which a door can be opened. Such devices are typically referred to as doorstops.

One simple type of doorstop merely comprises an elongate leg that is mountable to and extends outwardly from a wall so that the door contacts the tip of the leg before it contacts the wall. A rubber cap is usually provided on the end of the leg to reduce the amount of damage to the door by repeatedly contacting the leg.

Another type of doorstop is provided by an arm mounted to a door hinge, typically by a collar that mounts on the pivot pin of the hinge. The arm extends between the door and the wall or trim surrounding the doorjamb. When the door is opened to a certain position, one end of the arm contacts the door and the other end of the arm contacts the wall or trim surrounding the doorjamb. Adjustment of the degree to which the door can be opened is provided by adjusting the length of the arm; usually by a screw adjustment. Rubber caps are usually provided on both ends of the arm to reduce the amount of damage to both the door and to the wall or trim surrounding the doorjamb. However, repeated use of such a doorstop often results in damage to the door, to the wall or trim surrounding the doorjamb, or to both.

Other types of integral doorstops are disclosed in U.S. Pat. Nos. 516,546; 1,455,550; 2,660,750; 2,799,888; 3,178,762; 5,287,596 and 5,727,289 the disclosures of which are incorporated herein by reference. These other types of doorstops are not completely desirable because of the difficulty and expense of manufacturing.

Thus, a need exists for door hinge that includes a doorstop that does not damage either the door to which it is attached, to the wall or trim surrounding the doorjamb, or to both.

### SUMMARY OF THE INVENTION

The present invention satisfies the above-described needs by providing a door hinge comprising a first plate for attachment to a door, the first plate having an annular portion formed along an edge thereof; a second plate for attachment to a door jamb, the second plate having an annular portion formed along an edge thereof; and an elongate pivot pin received in the annular portions of the first and second plates, such that the first and second plates can pivot about the pivot pin from a closed position to an open position. Each of the first and second plates defines at least one hole for selectively receiving an elongate stop member. Each of the first and second plates also defines a slot extending radially outwardly from the at least one hole. An elongate stop member has a body portion and an enlarged head on each end thereof. The holes in the first and second plates are sized and shaped such that the enlarged heads of the stop member can pass there through. The slots on the first and second plates are sized and shaped such that the body portion of the stop member can pass there through, but the enlarged heads of the stop member cannot pass there through.

In another embodiment of the present invention, a method of providing a doorstop is described. The method comprises the step of inserting a stop member into an opening defined by each of the plate members that form a hinge attached between a door and a door jamb, said stop member having enlarged heads on each end thereof, such that when the door is moved from a closed position toward an open position, the enlarged heads of the stop member each contacts its corresponding plate of the hinge and prevents the door from moving beyond a desired position.

Accordingly, it is an object of the present invention to provide an improved door hinge.

Another object of the present invention is to provide a door hinge that includes an integral doorstop.

A further object of the present invention is to provide a doorstop that is relatively simple to construct and relatively inexpensive to manufacture.

Still another object of the present invention is to provide a doorstop that is relatively easy to attach and remove from a door hinge.

Yet another object of the present invention is to provide a doorstop that does not damage the trim surrounding the door or the door itself.

These and other objects, features and advantages of the present invention will become apparent after a review of the following detailed description of the disclosed embodiments and the appended drawing and claims.

### BRIEF DESCRIPTION OF THE DRAWING

FIG. 1 is an exploded perspective view of a disclosed embodiment of the door hinge apparatus of the present invention.

FIG. 2 is an alternate disclosed embodiment of the door hinge apparatus of the present invention.

FIG. 3 is a cross-sectional view of the apparatus shown in FIG. 1 taken along the line 3-3 and showing the apparatus attached to a door and a door casement or jamb.

FIG. 4 is a perspective view of the apparatus shown in FIG. 1 showing the hinge attached to a door and a door casement or jamb (shown in partial cutaway).

FIG. 5 is an alternate view of the apparatus shown in FIG. 3, showing the door in a closed position.

FIG. 6 is a partial detail view of another disclosed embodiment of the stop member of the present invention, showing an adjustable enlarged head.

FIG. 7 is a cross-sectional view of the adjustable enlarged head shown in FIG. 6 taken along the line 7-7.

### DETAILED DESCRIPTION OF THE DISCLOSED EMBODIMENTS

With reference to the drawing in which like numbers indicate like elements throughout the several views, it can be seen that there is a door hinge 10 for attachment between a door 12 and a door casement or jamb 14. The door hinge 10 comprises a first plate 16 for attachment to the door 12. The door hinge 10 also comprises a second plate 18 for attachment to the doorjamb 14. Formed in the first plate 16 are a plurality of holes 20. The holes 20 are sized and shaped to receive screws 22 for attaching the first plate 16 to the door 12 in a manner well known to those skilled in the art. Formed in the second plate 18 are a plurality of holes 24. The holes 24 are sized and shaped to receive screws 22 for attaching the second plate 18 to the doorjamb 14 in a manner well known to those skilled in the art.

Formed along an edge 26 of the first plate 16 are three annular portions 28, 30, 32. Each annular portion 28, 30, 32 defines a hole 34, 36, 38, respectively, which are aligned coaxially. These annular portions 28, 30, 32 can be formed by casting the first plate 16 and the annular portions 28, 30, 32 as a single piece, or the annular portions can be formed by bending the edge of a flat plate. Both types of construction are well known to those skilled in the art and are commercially available from numerous sources. Hinges 10 useful in the present invention are typically made from steel, aluminum, brass or other suitable metals or materials.

Formed along an edge 40 of the second plate 18 are two annular portions 42, 44. Each annular portion 42, 44 defines a hole 46, 48, respectively, which are aligned coaxially. These annular portions 42, 44 can be formed in the same manner as the annular portions 28, 30, 32.

When the first plate 16 and the second plate 18 are placed together to form the hinge 10, the annular portions 42, 44 fit between the annular portions 28, 30 and 30, 32, respectively. The holes 34, 36, 38 are also axially aligned with the holes 46, 48. When thusly aligned, a pivot pin 50 is inserted through the holes 34, 46, 36, 48, 38. The pivot pin 50 includes an enlarged head portion 52 which prevents the pivot pin from merely fall through the holes 34, 46, 36, 48, 38.

As will be appreciated by those skilled in the art, the second plate 18 attached to the doorjamb 14 is held in a stationary position. Whereas, the first plate 16 attached to the door 12 is free to pivot about the pivot pin 50. Therefore, the door 12 can pivot about the pivot pin 50.

The hinge 10 described above is conventional and well known in the art. The present invention comprises a modification of the prior art hinge described above. Those modifications will now be described.

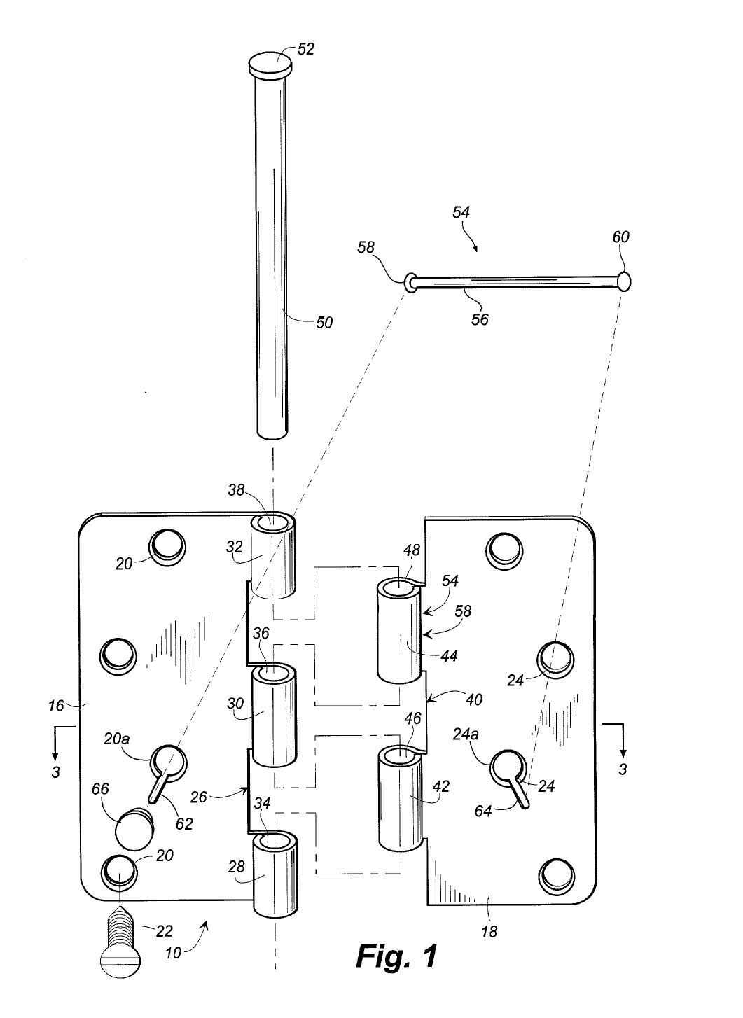

An elongate stop member 54 (FIG. 1) is provided. The elongate stop member 54 has a body portion 56 and enlarged head portions 58, 60 disposed at opposite ends of the stop member. The stop member 54 is made of any strong material, such as steel wire or rod, for example airplane cable. The enlarged head portions 58 and 60 can be formed by, soldering, welding, brazing, crimping, clamping and the like. The stop member can also be made from durable plastic, such as polypropylene and the like. When made of plastic, it is contemplated that the enlarged head portions 58, 60 can be formed integrally with the body portion 56, such as by molding. The elongate stop member 54 is desirable made in different lengths, such as 1½″, 2″ and 2½″, so as to provide different degrees of door opening, as will be described further below. The elongate stop member 54 is preferably rigid, yet slightly flexible. Therefore, braided stainless steel one-eighth inch airplane cable, such as available from All Star Nut & Bolt, Douglasville, Ga., is preferred.

Formed in the first plate 16 is a slot 62 that extends radially outwardly from the hole 20a. Also formed in the second plate 18 is a slot 64 that extends radially outwardly from the hole 24a. The slots 62, 64 can be formed by cutting a conventions hinge or they can be stamped during the manufacturing process.

As described above, the holes 20a and 24a are sized and shaped to receive screws 22. However, the holes 20a and 24a are also sized and shaped to permit stop member 54, including the enlarged head portions 60, 62 to pass there through. Additionally, the slots 62, 6 are sized and shaped to permit the body portion 54 of the stop member 54 to pass there through, but are sized and shaped not to permit the enlarged head portions 58, 60 of the stop member to pass there through.

Operation of the hinge of the present invention will now be considered. The hinge 10 is installed on the door 12 and the jamb 14 in the conventional manner, except as described below. In addition to drilling holes to accommodate the screws 22, it is necessary to drill holes (not shown) in alignment with the slots 62, 64. The depth of these holes may vary depending of the size of the stop member used. In the jamb 14, the hole only needs to be deep enough so that the enlarged head 60 does not prevent the plate 16 from mounting flush against the door. However, the hole drilled in the door 12 must be sufficiently deep so that the stop member can be received within this hole when the door is in a closed position (FIG. 5).

With the appropriate holes drilled in the door 12 and the jamb 14, the enlarged head 58 of the stop member 54 is placed through the hole 20a and the body portion 56 is slid down into the slot 62. The plate 16 is then positioned against the door 12 and screws 22 are placed in the holes 20, including the hole 20a, and fastened into the door. By placing a screw into the hole 20a, it can be seen that the enlarged head 58 of the stop member 54 cannot be pulled out of the slot 62 and the stop member cannot move into the hole 20a.

The enlarged head 60 of the stop member 54 is then placed through the hole 24a and the body portion 56 is slid down into the slot 62. The plate 18 is then positioned against the jamb 14 and screws 22 are placed into the holes 24, including hole 24a, and fastened into the jamb. By placing the screw into the hole 24a, it can be seen that the enlarged head 60 of the stop member 54 cannot be pulled out of the slot 64 and the stop member cannot move into the hole 24a.

Alternately, a plug 66 (FIG. 1) can be placed in the hole 20a. The plug 66 is held in the hole 20a only by friction, but it serves the purpose of retaining the stop member 54 is the slot 62 and preventing the stop member from pulling out of the hole 20a. This can ease installation of the door hinge of the present invention when relatively small angles of opening are desired. In those cases, it is desired that the plate 16 be mounted to the door 12 using screws in all of the holes 20 except 20a. Before the plug is placed into the hole 20a, the enlarged head 58 of the stop member 54 is placed through the hole 20a and slid into position in the slot 62. The plug 66 is then inserted into the hole 20a to retain the stop member in the slot 62.

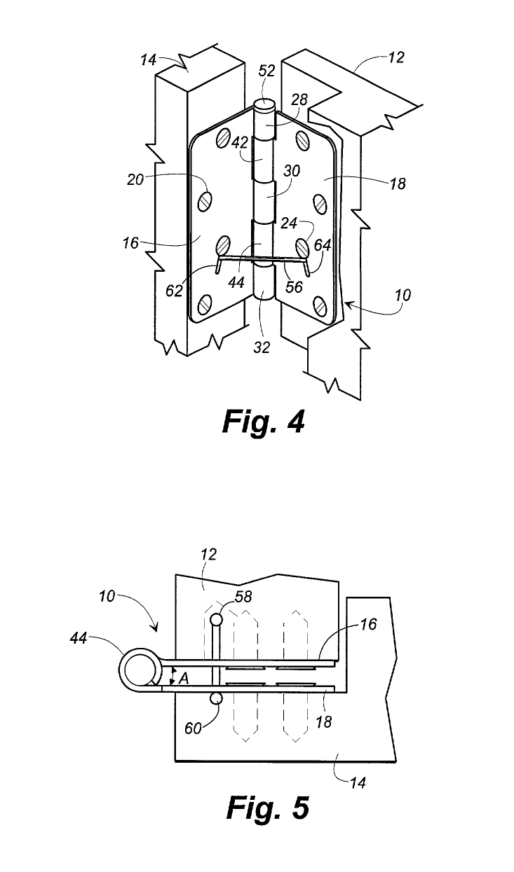

It will be appreciate that as the door 12 moves from the closed position (FIG. 5) to an open position, the stop member slides through the slot 62 until the enlarged head 58 contacts the plate 16. Furthermore, as the door 12 moves from the closed position (FIG. 5) to an open position, the enlarged head 60 of the stop member 54 is trapped between the plate 18 and the jamb 14 and is relatively motionless with respect to the slot 64. When the door 12 is move from an open position (FIGS. 3 and 4) toward a closed position, the body portion 56 of the stop member 54 will slide in the slot 62 and the stop member will be pushed back into the hole provided in the door 12 (FIG. 5).

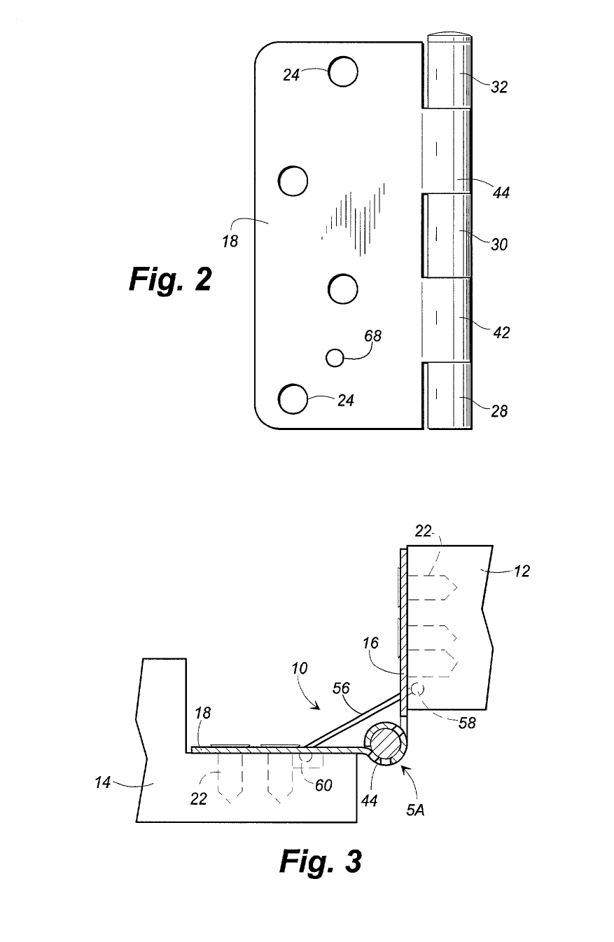

With reference to FIGS. 2, 6 and 7 there is disclosed an alternate embodiment of the hinge and doorstop of the present invention. Although the previous embodiment illustrates a hinge with slots provided intersecting the screw holes, it is also specifically contemplated that the present invention will work with hinges having separate holes provided for the doorstop. As shown in FIG. 2, the plate 18 has a hole 68 provided therein. A matching hole 70 (FIG. 7) is provided in the plate 16. The enlarged head 60 is conical in shape so that it will fit flush in the counter sunk hole 68 provided in the plate 18, thus avoiding the need to drill any additional holes in the jamb 14.

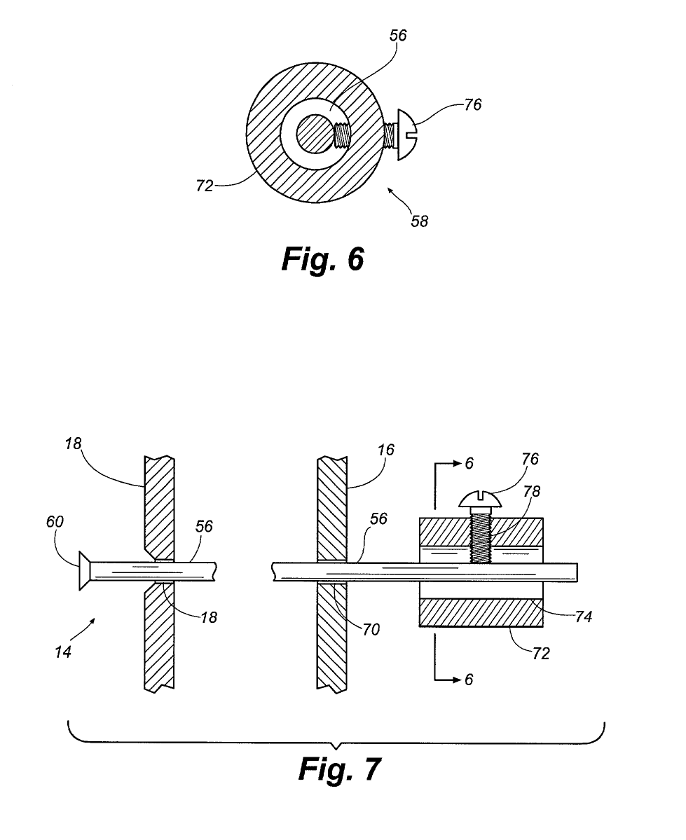

In this alternate embodiment, the stop member 54 is provided with an adjustable enlarged head 58 (FIG. 6). The adjustable enlarged head 58 comprises an annular collar 72 defining a central opening 74. The opening 74 is sized and shaped such that the body portion 56 of the stop member 54 can freely slide there through. A setscrew 76 is provided in a hole 78 having mating threads and arranged perpendicularly to the longitudinal axis of the opening 74 in the collar 72. The set screw 76 is sized and shaped such that when it is screwed into the collar 72 it will capture the body portion 56 of the stop member 54 so that the body portion cannot slide within the opening 74 of the collar. Loosening of the setscrew 76, permits the body portion 56 of the stop member 54 to again slide through the opening 74 of the collar 72. Thus, the collar can be adjustable fastened to the stop member 54 and thereby vary the effective length of the body portion 56 of the stop member. Of course, the collar 72 is of a size and shape such that it will not pass through the hole 70 provided in the plate 16.

The alternate embodiment of the present invention can be installed as follows. The body portion 56 of the stop member 54 is threaded through the hole 68 in the plate 18. The plate 18 is then attached to the jamb 14 with screws 22. The free end of the body portion 56 of the stop member 54 is then threaded through the hole 70 in the plate 16. The free end of the body portion 56 of the stop member 54 is then threaded through the hole 74 of the collar 72 and the setscrew 76 is tightened down onto the body portion at a desired position. The free end of the body portion 56 of the stop member 54 with the collar 72 fastened thereto is the placed in the hole provided in the end of the door 12 and the plate is fastened to the door with screws 22.

The collar 72 can also be used in conjunction with the embodiment utilizing the slot 62 in the plate 16. In this case, the collar is sized and shaped such that the collar and setscrew will pass through the hole 20a, but will not pass through the slot 62. Thus, if it is desired to adjust the opening of the door 12, the cap 66 can be removed from the hole 20a and the body portion 56 of the stop member 54 removed from the slot 62 and the collar pulled through the hole 20a. The position of the collar 72 on the body member 56 can then be adjusted as desired by loosening the set screw 76, sliding the collar on the body member to a desired location and retightening the set screw. The collar 72 can then be passed through the opening 20a, the body portion 56 slid down into the slot 62 and the cap 66 placed back into the hole 20a.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. An apparatus comprising:
a first plate for attachment to a door, said first plate having an annular portion formed along an edge thereof;
a second plate for attachment to a door jamb, said second plate having an annular portion formed along an edge thereof; and
an elongate pivot pin received in said annular portions of said first and second plates, such that said first and second plates can pivot about said pivot pin from a closed position to an open position;
each of said first and second plates defining at least one hole and a slot extending radially outwardly from said hole;
an elongate stop member received in said slot in said plates, said stop member having a body portion and an enlarged head formed on each of the ends thereof, said at least one opening being sized and shaped such that said enlarged heads can pass there through, said slots being sized and shaped such that said enlarged heads cannot pass there through, but said body portion can pass there through; and
whereby said enlarged heads contact said plates when said first and second plates are moved from said closed position toward said open position and said stop member prevents said first and second plates from reaching said open position.

2. The apparatus of claim 1, wherein said elongate stop member comprises a wire.

3. The apparatus of claim 1, wherein said elongate stop member comprises a flexible rod.

4. The apparatus of claim 1, wherein at least one of said enlarged heads comprise a collar defining a hole through which said body portion passes and a screw arranged in said collar such that it can capture said body portion in said collar.

5. A door hinge comprising:
a first plate for attachment to a door, said first plate having an annular portion formed along an edge thereof;
a second plate for attachment to a door jamb, said second plate having an annular portion formed along an edge thereof; and
an elongate pivot pin received in said annular portions of said first and second plates, such that said first and second plates can pivot about said pivot pin from a closed position to an open position; and
an elongate stop member attached at its ends to and extending between said first and second plates, whereby said stop member prevents said first and second plates from opening beyond a desired position.

6. The door hinge of claim 5, wherein said stop member is a flexible wire.

7. The door hinge of claim 5, wherein the length of said stop member is adjustable.

8. A hinge comprising two plates each having pivot bearings formed thereon and a pivot pin received in said pivot bearings so that said plates pivot about said pivot pin, said hinge further comprising a stop member extending through openings defined by each of said plates, said stop member having a body portion and enlarged heads on opposite ends thereof, whereby said body portion moves through said openings in said plates as the plates move from a closed position toward and open position and said enlarged heads contact said plates at a selected position intermediate an open position and a closed position, whereby said stop member prevents said plates from reaching said open position.

9. A hinge comprising two plates that pivot about a common pivot point, an elongate stop member attached at one end to one of said plates and extending through and movable in an opening defined by the other plate, a collar selectively longitudinally movable on said stop member such that said plates can pivot between a first and second position but cannot pivot beyond a desired position.

10. A method of providing a doorstop comprising the step of inserting a stop member into opposite hole defined by opposite plates of a hinge attached between a door and a door jamb, such that when said door is moved from a closed position toward an open position, said stop member moves in at least one of said openings and an enlarged head on at least one end of said stop member contacts its corresponding plate of said hinge and prevents said door from moving beyond a desired position.
